(19) United States
(12) Patent Application Publication
(10) Pub. No.: US 2025/0373950 A1
(43) Pub. Date: Dec. 4, 2025

(54) MULTIANGULAR DYNAMIC IMAGING SYSTEM AND METHOD FOR MEASURING AND EVALUATING OVDS

(71) Applicant: Ernesto Gonzalez-Candela, Mexico City (MX)

(72) Inventor: Ernesto Gonzalez-Candela, Mexico City (MX)

(21) Appl. No.: 19/222,025

(22) Filed: May 29, 2025

Related U.S. Application Data
(60) Provisional application No. 63/653,686, filed on May 30, 2024.

(51) Int. Cl. H04N 23/695; G06T 5/50; G06T 5/70; G06T 7/246; G07D 7/1205; H04N 23/11; H04N 23/56

(52) U.S. Cl. CPC H04N 23/695; G06T 5/50; G06T 5/70; G06T 7/248; H04N 23/11; H04N 23/56; G06T 2207/20132; G06T 2207/30176; G07D 7/1205; G07D 2207/00

(57) ABSTRACT

A Multi-Angle Dynamic Image system provides multi-angle observation capabilities comprising lamps strategically positioned to obtain high quality images of the security documents or items under analysis, to obtain images with variations in the observation angle of the security document or item under study. The system includes a box platform for placing the security document or item thereupon, the box platform changes its orientation, allowing the system to capture the variations in color and structure as the orientation and the angles of the observation and illumination change. The system also includes a high-resolution linear camera to capture the intricate details while avoiding distortion and parallax issues. The system also includes a computer configured to run algorithms to process image acquisition data for a complete set of observation angles, to pre-process image acquisition data including crop and image standardization, to calculate differences between adjacent angle images, eliminate noise, to calculate a total optical flow using the images at different angles and their differences to generate the Dynamic Images vectorial field, one per orientation, and the Dynamic Map, a heat map generated using the magnitude from the Dynamic Image vectorial field, and calculate from the Dynamic Image the different parameters associated with dynamic properties of the OVD.

### TECHNICAL FIELD OF THE INVENTION

The field of the invention is related to the evaluation of optically variable devices (OVD) to quantitatively determine their functionality in terms of visual perception in a measurable manner.

### BACKGROUND OF THE INVENTION

In today's world, the protection against counterfeiting of security documents (banknotes, passports, IDs, licenses, and other government documents), pharmaceutical products and many other valuable or luxury items rely heavily on security features known as Optically Variable Devices (OVDs). These OVDs feature dynamic effects such as changes in appearance, apparent movement, and changes in color among others, depend on the angle of observation or illumination, and provide a crucial role in discerning items from counterfeits to verify their authenticity.

It is known that different OVDs technologies or designs have different visual effects when tilted that drive the user's attention in a different way.

It is known that OVDs in new documents are different (visually noticeable) than those in worn or counterfeited documents. It is also known that counterfeit documents may have reproductions of OVDs that are usually of low quality and visually different than those found in original documents.

There is no method for quantitively determining the characteristics of an OVD in terms of its visual functionality. That is, there is no way to quantify a parameter that indicates the functional properties of an OVD, so that you can compare between different OVD technologies or designs or so that you can compare an OVD in a new document with respect to one that has been worn down by use or a genuine OVD with respect to a counterfeited OVD.

US 2006/0244948 A1 describes a method that comprises measuring spectral data of the object under a first illumination condition and a second illumination condition. The second illumination condition is different than the first illumination condition. The method also comprises determining a presence of the security feature based on the spectral data measured under each illumination condition and comparing the security feature to a standard.

US 2002/0191175 A1 describes a system and methods for automatically verifying the authenticity of an object by scanning for an optical interference security feature having predetermined optical spectral characteristics. The optical characteristics and/or spectral shift is compared with stored reference data to verify the authenticity of the security feature and hence the object.

In this regard, it is very important to study if OVDs perform properly in aspects such as their ability to:
effectively attract attention of users
be easily differentiated from counterfeits
maintain resistance to common degradation processes in security documents.

Therefore, it is imperative to assess the performance of these OVDs in security documents quantitatively and objectively by identifying the parameters directly related to their visual functionality and performance. This allows for a quantitative comparison of different OVDs, moving beyond subjective evaluations by experts.

### SUMMARY OF THE INVENTION

A first object of the invention is to provide an apparatus and method to assess quantifiable parameters associated with the performance of an OVD.

Another object of the invention is to provide a method to quantitatively compare security documents having an OVD.

Another object of the invention is to provide an apparatus and method for determining whether an OVD in security documents maintains optical properties after the common wear or degradation by use.

Another object of the invention is to provide an apparatus and method to quantitatively determine the differences between genuine and counterfeited OVDs.

A further object of the invention is to provide an apparatus and method for identifying security documents in which the OVD does not attract enough of the attention of the user to ensure the differentiation between genuine and counterfeited.

Still another object of the invention is to provide an apparatus and method for determining whether an OVD in a security document can be designed to be as much as possible visually differentiated from counterfeits.

These objects are reached providing a Multi-Angle Dynamic Image system comprising (a) a box platform, to support a security document or item; (b) an image acquisition device, comprising a linear camera, to obtain a plurality of digital images in a variety of angles from the security document, to capture variations in color and structure as the orientation and observation angles of the linear camera and illumination change; and (c) a computer, configured to (i) control the linear camera and store a digital image files for the different angles, (ii) conduct image preprocessing including cropping, homologation, (iii) calculate the difference between images of digital images files of adjacent angles and create and store a second version digital image files, (iv) provide for elimination of noise and undesired structures from the differences of digital image files, and store a second version of digital image file, (v) obtain a Dynamic Image which is a vectorial field defined by a magnitude and a direction, calculated from the difference between images of digital images; (iv) generate a Dynamic Map, which is a heat map calculated using the magnitude at each vector of the Dynamic Image, and (v) generate movement magnitude parameter and comparisons parameters.

### BRIEF DESCRIPTION OF DRAWINGS

FIG. 1 shows the Multi-Angle Dynamic Image Scanner apparatus (1) of the present invention.

FIG. 2a and FIG. 2b show two particular scan orientations, transverse and longitudinal, respectively, in the apparatus (1) of the invention.

FIG. 3 shows a diagram of the method to assess quantifiable parameters associated with the performance of an OVD in the Multi Angle Dynamic Image Scanner apparatus (1) of the present invention.

FIG. 4 shows the Dynamic Map (b) generated from a security document (a).

### DETAILED DESCRIPTION OF THE INVENTION

Since all OVDs in security documents, banknotes and other valuable items share the characteristic of changing their appearance depending on the angle of observation or illumination. The invention presented here consists of a system composed of an instrument focused on capturing a plurality of digital images of the OVD in the security document at different angles of observation or illumination, which captures the OVD properties and visual characteristics and, subsequently through a configured computer, quantify such images and run a series of algorithms to process every image and generate diverse outputs as a result, which are intended to objectively visualize, measure, and compare the characteristics of the mentioned changes.

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

The system consists of a specially designed image acquisition device for capturing specific types of images from physical security documents, banknotes, and other valuable items as well as a computer configured to execute algorithms for processing these images and generating the various outputs. Being such outputs are quantifiable properties associated with the visual performance of an OVD.

The image acquisition device serves two crucial functions. Firstly, it ensures precise control over the acquisition parameters, including the angles with respect to the sample under analysis for both the capture and the illumination. This ensures the acquisition of high quality and standardized digital images suitable for quantitative and objective analysis. The standardization and the quality of the images allows for direct comparison of image analyses across different samples, facilitating accurate benchmarking exercises.

Secondly, the device is capable of capturing images from a diversity of angles and orientations. This feature enables the detection and analysis of any movement, color changes, or dynamic effects in security features such as optically variable devices (OVDs) that naturally occur when security documents are subjected to tilting. This capability is particularly valuable for evaluating OVDs because it reproduces how the public uses and perceives these kinds of security features on the field.

### Image Acquisition & Equipment: Illumination, Observational Changes and Dynamic Images

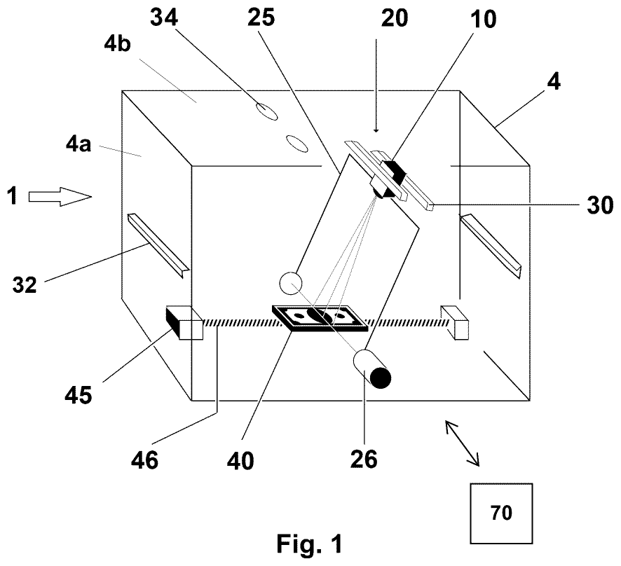

FIG. 1 shows the Multi Angle Dynamic Image Scanner apparatus 1 of the present invention. The Multi Angle Dynamic Image Scanner apparatus 1 comprises a housing 4 in which an image acquisition device 20 is placed in to acquire images in an isolated form, preventing external light from distorting the data and measures obtained. Housing 4 includes housing fixed lamps 32, 34 arranged in the inner and upper walls 4a, 4b of the housing 4.

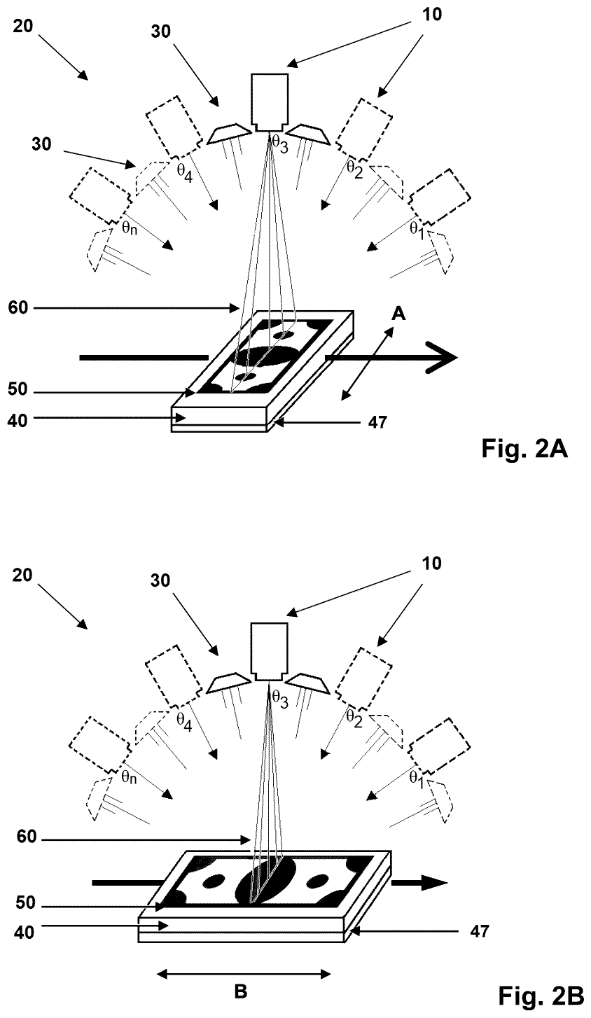

The image acquisition device 20 comprises a platform. In accordance with a preferred embodiment, the platform is a box platform 40 which moves from left to the right-hand side in FIGS. 1, 2A and 2B by means of an actuator 45 that drives the platform 40 through a guide rail 46 associated to the platform 40, and which can be oriented in any direction, as shown in FIGS. 2A and 2B where two different orientations are shown.

The box platform 40 is a structure having side and bottom dark walls and an upper translucid wall where a document is attached to conduct the analysis.

In accordance with an embodiment the box platform 40 optionally comprises in its bottom, a source of light 47. The source of light 47 provides backlight illumination beneath the security document or item 50 that is placed on the box platform 40, allowing for the capture of images with transmitted light, essential for highlighting specific details of certain OVDs.

The security document 50 is attached to the translucid upper wall of the box platform by bonding means, which includes adhesive, mechanical fasteners and the like.

The box platform 40 is able to rotate in order to change its orientation (see FIG. 2A and FIG. 2B), allowing the system scanning the security document longitudinally or transversally, or any other orientation. Such rotation movements are caused by a servomotor (not shown) placed below the box platform and controlled by a computer 70.

It also includes an articulated fork 25 joined in its base to at least one actuator 26 such as motor or servomotor controlled by the computer 70, fixedly placed in the housing 4, the fork comprises two legs and an upper part connecting the legs. The actuator 26 causes the fork 25 to deploy an angular movement from 0 to 180°, to capture the OVD variations in color and structure as the orientation and the observation angle change.

A preferred embodiment of the invention device includes a high-resolution linear camera 10.

The featuring at least one lamp 30, and a high-resolution linear camera 10 are arranged in the fork 25, directed to the box platform 40 where the security document is placed, in order to illuminate and to obtain high quality images of the OVDs under analysis. In order to obtain images with all possible observation variations in the orientation of the security document or item 50, as depicted in FIG. 2A and FIG. 2B, the fork 25 allows the linear camera 10 and lamps 30 to deploy at different angles θ1, θ2, θ3, θ4, . . . θn.

At the core of this system lies a high-resolution linear camera 10, to capture the intricate details of the security document or item 50.

The design also considers a box platform 40 for placing the security document or item 50 that provides backlight illumination, allowing for the capture of images with not only reflected but also transmitted light, essential for highlighting the specific details of certain OVDs in security documents or items 50.

Throughout the image acquisition process, the box platform 40 smoothly advances in the guide rail 46 through the camera's focus zone 60 the by means of the actuator 45, enabling the camera 10 to capture the entire security document or item 50 (which in accordance with a preferred embodiment is a banknote).

In another aspect, a Multi-Angle Dynamic Image system 1 includes multi-angle observation device comprising lamps strategically positioned to obtain high quality images of security documents or items under analysis, to obtain images with variations in the observation angle of the security document or item under study. Alternatively, the Multi-Angle Dynamic Image system includes a computerized Delta Robot, well known in the art, which enables the linear camera to assume any position in the tri-dimensional space, inside the housing 4, allowing one to obtain the plurality of digital images of the security document taken from multiples angles.

The Multi-Angle Dynamic Image system 1 comprises a box platform 40 where security document 50 is placed. The box platform 40 changes its orientation, allowing the system to obtain a plurality of digital images, capturing the variations in color and structure of the OVDs as the orientation and angles of the observation and illumination change. The Multi-Angle Dynamic Image system 1 also comprises a high-resolution linear camera 10 to capture intricate details while avoiding distortion and parallax issues. In an embodiment the linear camera is 4 k resolution. The plurality of digital images obtained using different observation angles of the linear camera and illumination are stored in a computer storage device of the computer 70 that is connected to the camera 10.

In accordance with some embodiments the Multi-Angle Dynamic Image system optionally includes NIR (Near InfraRed) illumination and NIR capturing capabilities, allowing the Multi Angle Dynamic Image Scanner apparatus (1) to capture dynamic effects in a zone of a spectrum comprising NIR (Near InfraRed, typically between 800 and 900 nm) illumination and NIR capturing capabilities. In a preferred embodiment, the NIR capturing device is the same linear camera 10 capable of capturing images in the NIR wavelengths of the spectrum as well as for visible light.

In accordance with some embodiments the box platform 40 smoothly advances through a focus zone 60 of the linear camera 10, enabling the linear camera 10 to capture an entirety of the security document or item 50, for example documents or banknotes.

In another aspect of the invention, a method is provided to objectively assess OVDs, with the use of the Multi-Angle Dynamic Image system. The method comprises image acquisition processing for a complete set of observation angles and in any orientation; image pre-processing including crop and image standardization; calculating the difference between adjacent angle images; noise elimination including applying filters and other algorithms to get rid of noise and structures not corresponding to the dynamic features or OVDs, such as document reliefs and crumples; Dynamic Images generation, to calculate, by means of an algorithm, the total optical flow using as input the images at different angles and their differences to obtain a resultant optical flow vectorial field, called Dynamic Image, for each orientation analyzed; Dynamic Map generation for visualization wherein, using the magnitude at each pixel of the Dynamic Image vectorial field, a heat map is calculated resulting in the Dynamic Map; calculation, from the Dynamic Images, of different parameters associated with dynamic properties of the OVD.

To achieve the objective of capturing, visualizing, and measuring dynamic effects such as movement or color changes, the instrument introduces the concept of Dynamic Images. These Dynamic Images are vectorial fields containing information of the magnitude and direction of any change or movement in each region of the security document or item 50 under analysis, as a function of the variation of the observation angle. In order to visualize these structures, a heat map, called Dynamic Map, is created from the Dynamic Image which displays the magnitude of the vectorial field depicting the magnitude of movement in each zone. The method is capable of creating one Dynamic Image, and its correspondent Dynamic Map, in each orientation analyzed, allowing to depict movement when the security document or item 50 is tilted in those orientations. If for example, the longitudinal and transversal orientations are selected, the Dynamic Images corresponding to these orientations will depict the effects when the security document 50 is tilted up and down in the direction of A (FIG. 2A) or is tilted left and right in the direction of B (FIG. 2B).

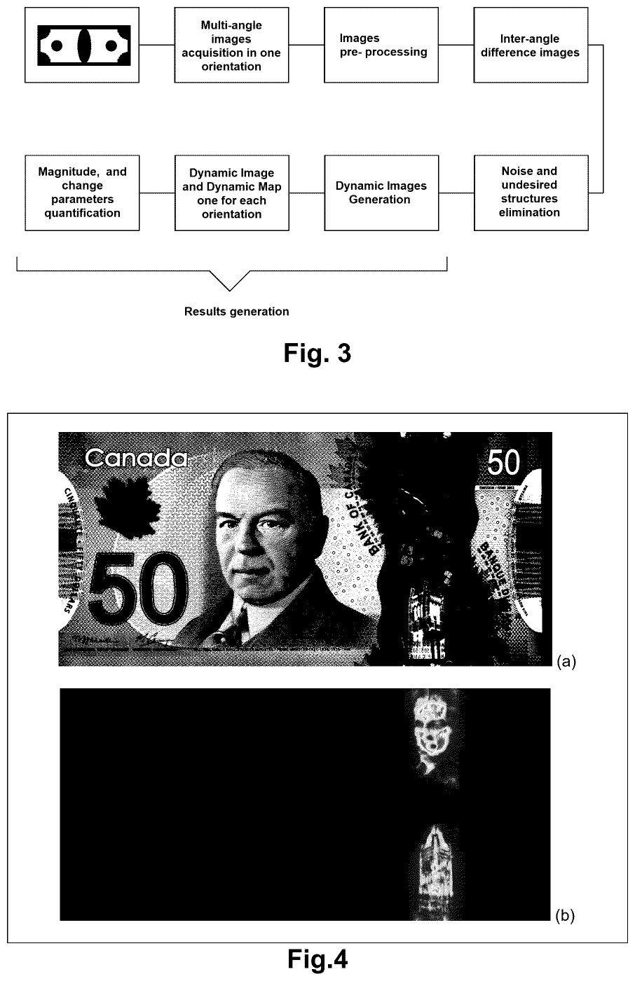

Referring to FIG. 3, the procedure to generate the Dynamic Image of an OVD for each orientation is described as follows:
1. Image acquisition. For the complete set of observation angles in the desired orientation.
2. Image pre-processing. Image cropping and homologation.
3. Inter-angle difference images. Calculate the difference between images of adjacent angles.
4. Application of filters and other algorithms to get rid of noise and structures not corresponding to the dynamic features or OVDs effects, such as document reliefs or crumples.
5. Dynamic Image generation-one per orientation. By means of an algorithm, calculate the total optical flow from the images at different angles and their differences.
6. Dynamic Map generation-a heat map is calculated using the magnitude at each pixel of the Dynamic Image.
7. Parameters generation-obtaining an OVD Movement Magnitude Parameter value from the Dynamic Map correspondent to total magnitude within the region of the OVD and representing the magnitude of movement of that OVD, and obtaining a parameter of difference or change between two OVDs.

In other words, the main result is a vectorial field that corresponds to the Dynamic Image. In order to visualize it, a heat map called Dynamic Map is generated, depicting higher values in areas where OVDs exhibit more change or movement, and zero values where no movement is detected. Dynamic Images quantify the extent and direction of image change across an OVD resulting from a change in viewing angle, while the Dynamic Map offers a visualization of the intensity of this image change.

The Dynamic Images and Dynamic Maps obtained, besides serving to visualize the movement in an OVD, can be used to obtain different parameters and information associated with the dynamic properties of the OVD. The first and more obvious is a parameter related to the magnitude of movement for each OVD or region of OVD (Movement magnitude parameter). This parameter is calculated by adding the total magnitude from the Dynamic Map within the region correspondent to the OVD, and then dividing it by the total area of the region.

Finally, an important parameter is the difference or change between two OVDs or between two different conditions or stages of the same OVD (different levels of wear or a genuine as compared to a counterfeited, for example). This parameter is obtained calculating the correlation between the Dynamic Images of the samples in the two different conditions or stages. As it will be clear with the applications, this parameter results very useful for assessing durability and for counterfeiting detection purposes. The system includes the calculation of all these parameters as part of the process.

These Dynamic Images and the resulting parameters have a wide array of practical applications. Serving as a measure of change or motion, they play a crucial role in objectively determining the level of attention an OVD will produce.

Additionally, this methodology can be employed to compare the properties of genuine and counterfeit OVDs, providing a method to differentiate between them and providing insights into their security strengths and weaknesses.

Another significant application lies in evaluating the durability of OVDs. By comparing Dynamic Images of the same OVD at different stages of wear, one can quantitatively assess the decline in performance. This facilitates a thorough evaluation of OVD performance under non-ideal conditions.

Moreover, during the design phase of OVDs, this tool offers a means of measuring and comparing the performance of various designs, colors, or sizes of the same OVD.

In addition, for research and development activities, this approach enables the evaluation of new OVD technologies and the identification of those with superior performance.

In essence, this tool proves invaluable in the decision-making process concerning OVDs by offering a comprehensive overview for comparing and contrasting their performance in an objective and quantitative manner. This ultimately enables organizations to make more informed choices that align with their specific needs and goals.

### Example 1

FIG. 4 Shows a security document (a) analyzed and the resulting Dynamic Map obtained (b) from the vectorial treatment. The movement magnitude parameter was calculated for OVD in the security document. The result for the upper OVD (a face) is a movement magnitude of 2.02, while the lower part (a tower) has a movement magnitude of 1.82.

### Example 2

Table 1 represents correlation parameters obtained from comparing between two new OVDs, and a new OVD against a worn OVD and against a counterfeited OVD:

TABLE 1
Correlation parameters obtained from comparing different OVDs

| | Type of comparison | Correlation |
|---|---|---|
| 1 | New OVD vs a different new OVD | 0.99 |
| 2 | New OVD vs a worn OVD | 0.53 |
| 3 | New OVD vs counterfeited OVD | 0.21 |

While the preferred embodiments have been shown and described, it will be understood that there is no intent to limit the invention by such disclosure, but rather, is intended to cover all modifications and alternate constructions falling within the spirit and scope of the invention.

1. A Multi-Angle Dynamic Image system comprising:
a box platform, to support a security document or item, the box platform comprises an actuator for displacement of the box platform on a guide rail;
an image acquisition device, comprising a linear camera, to obtain digital images from the security document, and a mechanical device to allow the linear camera to deploy an angular movement in order to capture images of a security document or item in a plurality of angles, capturing variations in color and structure as orientation and observation angles of the linear camera and illumination change; and
a computer, configured to control the actuators and the linear camera and store digital image files.

2. The Multi-Angle Dynamic Image system according to claim 1, wherein image acquisition device comprises:
an articulated fork, attached in its base to at least one actuator associated to a servomotor controlled by a computer, the servomotor fixedly placed in a housing, the fork comprises two legs and an upper part connecting the legs, the actuator causes the fork to deploy an angular movement from 0 to 180°;
a high-resolution linear camera, arranged in the upper part of the fork;
at least one lamp, arranged in the upper part of the fork, adjacent to the linear camera.

3. The Multi-Angle Dynamic Image system according to claim 1, further comprising a housing and housing lamps arranged on inner and upper walls of the housing.

4. The Multi-Angle Dynamic Image system according to claim 1, further including NIR (Near InfraRed) illumination and NIR capturing device, to capture dynamic effects in a spectrum range from 800 to 900 nm.

5. The Multi-Angle Dynamic Image system according to claim 1, wherein the box platform comprises a source of backlight integrated to the box platform, the box platform provides backlight illumination beneath the security document.

6. The Multi-Angle Dynamic Image system according to claim 1, wherein the box platform comprises an actuator for rotation of the box platform to allow the platform to orientate in any direction.

7. A Multi-Angle Dynamic Image system implemented by computer, comprising a computer configured to
obtain a plurality of digital images files obtained in a variety of observation angles using a linear camera, and store them in a storage device associated with the computer;
calculate the difference between images of digital images files of adjacent angles, and obtain Dynamic Images in the form of vectorial fields defined by a magnitude and a direction;
generate a Dynamic Map using the magnitude value at each vector of the Dynamic Image; and
generate a movement magnitude parameter.

8. A Multi-Angle Dynamic Image system implemented by computer according to claim 7, the computer further configured to
conduct an image pre-processing including: cropping and homologation of the plurality of digital image files, and create and store of digital image files.

9. A Multi-Angle Dynamic Image system implemented by computer according to claim 7, the computer further configured to
conduct elimination of noise and undesired structures of the plurality of digital image files, and create and store of digital image files.

10. A method to assess OVDs movement magnitude parameters implemented by computer, the method comprising:
providing a Multi-Angle Dynamic Image system according to claim 1, comprising a box platform, to support a security document or item;
processing security document digital image acquisition, for a complete set of observation angles and in any orientation;
image pre-processing, including crop and image standardization;
calculating a difference between adjacent angles digital images;
conduct elimination of noise and structures not corresponding to the dynamic features or OVDs, such as document reliefs and crumples;
generation of Dynamic Images, one per orientation, to calculate, by means of an algorithm, a total optical flow using the images at different angles and their differences to obtain a dynamic Image, composed of a vectorial field for each orientation analyzed;
generation of a Dynamic Map, for visualization using a magnitude at each pixel of the Dynamic Image vectorial field, a heat map is calculated resulting in the Dynamic Map; and
calculation, from the Dynamic Map, of movement magnitude parameters associated with dynamic properties of the OVD.

11. The method to compare OVDs, according to claim 10, further comprising a step of calculation correlation between Dynamic Images of the same OVD in different levels of wear or between a genuine and its counterfeited version.
